(19) United States
(12) Patent Application Publication
(10) Pub. No.: US 2019/0224057 A1
(43) Pub. Date: Jul. 25, 2019

(54) Load-carrying System

(71) Applicant: Albert Jordan, Chicago, IL (US)

(72) Inventor: Albert Jordan, Chicago, IL (US)

(21) Appl. No.: 16/223,422

(22) Filed: Dec. 18, 2018

Related U.S. Application Data
(60) Provisional application No. 62/607,973, filed on Dec. 20, 2017.

(51) Int. Cl. A61G 5/06; A61G 5/02; A61G 5/10; G06K 9/00; G05D 1/10

(52) U.S. Cl. CPC A61G 5/066; A61G 5/061; A61G 5/023; A61G 5/068; A61G 2203/30; G06K 9/00805; G05D 1/10; A61G 2203/10; A61G 5/104

(57) ABSTRACT

A load-carrying system for ascending and descending an obstacle and for connection to a load-carrying device is disclosed. A computer system, with means for receiving data from an obstacle warning system of sensors on the exterior surfaces of an obstacle riser, stores the data in data storage system and signals said device to proceed with ascending or descending the obstacle. The risers follow the up, down or angular movements of a climbing base while a hydraulic beam permits longitudinal movement in combination with the riser.

This application claims priority of U.S. Provisional Application Ser. No. 62/607,973 filed Dec. 20, 2017, the entire contents of which are incorporated herein by reference thereto.

### BACKGROUND OF THE INVENTION

The present invention relates to a load-carrying system for ascending and descending an obstacle using sensor-operated engagement riser combinations. The load-carrying system is preferably connected to a load-carrying device such as a power lift wheelchair capable of ascending or descending stairs and curbs.

The load-carrying system can have a computer system with means for receiving data from an obstacle warning system of sensors and storing the data in a data storage system. The data storage system reads, reviews and measures the data from the obstacle warning system.

The load-carrying system, when used in conjunction with a power lift wheelchair, is designed to give physically challenged individuals more freedom to live independently while addressing some of their more difficult problems.

Safe travel in a wheelchair is an important part of the vibrant economic life of any municipality. Wheelchair amenities such as wide sidewalks, crosswalks, curb cuts, landscaping, etc. are examples of basic requirements that make areas safe and livable. Deficiencies in the above mentioned amenities have a disproportionate impact on people with disabilities and more importantly those that depend on the use of a wheelchair or similar transit items. Their most important means of independence would be severely disrupted.

Major cities have angled stairs that are tricky to maneuver or squeezed onto sidewalks or narrow buildings. Additional hazards mount as these stairs can be circular or winding. Often these stairs have stair treads and entry points that are not parallel to the front of the wheelchair or the direction of travel. These obstacles invite accidents as well as toppled wheelchairs or similar transportation devices.

Since many wheelchair users rely on public transportation, the federal and state governments have adopted policies that recognize the importance of pedestrian infrastructure. Most policy makers recognize that an integral step in encouraging people to use public facilities (including streets, public stairways, sidewalks and public transportation) is that of retrofitting and constructing complete streets and public passageways. These elements of the public sector are designed and operated to facilitate safe access for all users. Wheelchair operators or similar transit user of all abilities are able to safely move along the sidewalk, cross streets, or climb stairs.

In general, stairs are multidimensional and may be straight, round, or consisting of two or more straight pieces connected at angles. Pie steps are utilized instead of a landing to change the direction of a staircase. Angled, winding, or curved stairs are stairways that do not incorporate a flat rectangular turning space for intermediate landing. The general lack of uniformity and angular disposition of these stairs provide a particular trip hazard and are often unsafe for walking. The typical 90-degree turn in the angled stair is enforced with sequential triangular stair treads. This produces irregular and minimal stepping areas and walking near the inside corner of the turns are difficult. This difficulty is coupled with the lack of an intermediate landing.

Stair and curb-climbing wheelchairs have been described in published patents and patent applications. For example, Inventor Jayne invented the stair-climbing wheelchair described in U.S. Pat. No. 4,618,155. The invention consists of a chair seat having parallel elevating levers keeping the chair in a substantially horizontal position and a plurality of linear bearings connected to a plurality of wheelchair-supporting and transporting wheels. The stairs are climbed by backing the wheelchair to the bottom of stairs, adjusting the feet of the wheelchair and the wheels to a certain height of a stair riser, moving elevating levers, and locking the wheels from rotation. The Jayne invention would not provide the balance needed to successfully climb stairs as the user would have to constantly manipulate the elevating levers and at the same time measure the distances of the wheel in relation to the stair heights. The chair also lacks any means of turning curved landings. This further limits its mobility and usefulness.

The Grier invention demonstrated in U.S. Pat. No. 3,226,128 utilizes fore-and-aft skids being connected to the interior axes of drive wheels. A gripping means holds the chair on the stairs while the skids move the chair up the stairs, with the skids resting on the noses of the stairs at intervals. Similar to the aforementioned stair climber by inventor Jayne, the user would struggle to maintain balance while using the wheelchair. The skids resting on the noses of the stairs is also limiting and would make the chair more susceptible to toppling.

The stair-climbing wheelchair of Inventor Joslyn was presented in U.S. Pat. No. 3,269,478. The chair used a pair of hydraulic lifting legs positioned on each side of the chair. The chair advances up stairs by cylinders lifting the chair. The cylinders moved above pivots while chair is set on leveling feet. The mechanisms used in conjunction with the chair base appear difficult to use and would pose great difficulty on narrow or winding stairs.

Additional stair and curb-climbing wheelchairs integrating path planning, available maps, floor plans, and architectural information already exist in the prior art. Some include three-dimensional computer models of a building's interior and exterior. However, these devices are mainly used for navigation inside of a home or small-scaled outdoor areas such as a garden. In these cases, it is expected that the map or floor pan is established and easily generated. These features have limited desirability as the regions for use as well as the features of these devices are limiting.

It is always possible to encounter unexpected obstacles in the way of a wheelchair and overcoming the obstacles is often not accomplished automatically. To that end, personal chairs specially adapted for patients or disabled persons, wheelchairs with obstacle mounting facilities, and wheelchairs for climbing flights of stairs are known. Such vehicles are generally configured to crawl up or down stairs or similar obstacles. For example, one such vehicle includes a plurality of wheels being mounted under the vehicle body and a segmented track being grouped around the wheels. In addition, fastening pincers are disposed on the outer perimeter of the belt. The vehicle ascends and descends obstacles such as stairs when each pincer penetrates the surface. Such ascending and descending vehicles are difficult to use and the plurality of wheels make the device unstable and difficult to control. The surfaces also sustain damage from each pincer as the user maneuvers the device up and down the obstacles.

There have been attempts to provide such a vehicle with a mechanism, which maintains the seat in a horizontal position, since the vehicle body itself is inclined when going up or down a set of stairs. However, in order to maintain the seat in the horizontal state, the angle between the vehicle body and the seat must be maintained at the same angle as the inclination of stairs. Mechanisms which control the angle between the seat and the vehicle body are usually complicated structures that are expensive to manufacture.

Obstacle detection and avoidance is also a system design requirement for planetary exploration vehicles and micro-robotic vehicles. Some of the technology has been transferred to the development of wheelchair and various transit applications. The various types of vehicles might necessarily face different environmental obstacles and the technologies have been modified. However in some cases, the technology is slightly modified or simply identically transferred to wheelchairs to solve steering and navigation problems.

Digital protractors are also well known in the art. There are many devices in the marketplace that are used for digitally measuring angles. These devices are commonly used in the construction industry as well as for the manufacturing of tools and other household items. For example, a digital protractor can be used for setting or marking construction angles on woodword, surfaces and work pieces. However, digital protractors typically do not operate in restricted spaces or with machinery.

To this end, the load carrying system of the present invention is presented. It is an object of the invention to provide a load carrying system that overcomes the aforementioned difficulties and enables a user to climb stairs, curbs and other obstacles without much difficulty by using sensor-operated engagement riser combinations.

### BRIEF SUMMARY OF THE INVENTION

It is therefore an objective of the present invention to address the above concerns and to provide a load-carrying system for ascending and descending an obstacle using sensor-operated engagement riser combinations.

As such, the general purpose of the present invention is to provide a new and improved load-carrying system that features a plurality of sensors that collect data and transfer said data to a centralized processor.

Another objective of the present invention is to provide a new and improved processor that receives data and coverts said data into output information that allows a load-carrying device to operate. Said processor being presented herein and said processor storing said data in various segments.

Another object of the present invention is to provide a sensor system that in most instances would measure the distance and position of the load-carrying system, communicate with said processor, and said processor determining if a proposed travel range or motion is safe. The processor then suggesting the next sequence of positioning for safe travel or movement.

Another object of the present invention is to provide a sensor system wherein the load-carrying system is thereby adapted to transmit information to a digital protractor integrated into individual pie risers to assist the user to navigate angles in tight spots. This protractor provides on-site and in-use digital angle reading using full circle 0-90° and 90°-0 readings as necessary on the left side or right side of a stair riser.

Still another objective of the present invention to provide a load-carrying system wherein each engagement riser extend laterally on a conveyor belt and is engageable into reach positions along a hydraulic arm. Each engagement riser being engageable along the bottom thereof with the reference surface including stairs, sidewalks, flat surfaces, etc. Sensors are secured to each riser for operatively cooperating with the computer system that can display the angular displacement of the arm.

Henceforth, a new load-carrying system that is capable of ascending or descending stairs, curbs and other obstacles using a sensor-operated riser combination would fulfill a need in the art. This invention utilizes and combines known technologies in a new configuration in order to overcome a long felt need in the art.

Additional advantages of the invention will become apparent from the following detailed description taken in conjunction with the accompanying drawings.

### BRIEF DESCRIPTION OF THE SEVERAL VIEWS OF THE DRAWINGS

FIG. 1 is side perspective view of the load-carrying system being used on a power lift wheelchair.

FIG. 2 shows the ascending arm being integrated in the rear seating arrangement of a power lift wheelchair.

FIG. 3 shows the ascending arm being integrated in the rear seating arrangement of a power lift wheelchair and the risers being directed in a lateral direction in preparation for deployment.

FIG. 4 shows the load-carrying system in the ascending form with the risers being guided by a plurality of guide wires along the conveyor belt system.

FIG. 5 shows the load-carrying system in the ascending form with the risers being guided by a plurality of guide wires along the conveyor belt system.

FIG. 6 shows a bottom deployment unit that can be used to house a load-carrying system in the descending form.

FIG. 7 is a rear plan view of a load-carrying device showing the motor being outwardly disposed at the rear along with extending hydraulic tubes and electrical wires.

FIG. 8 is a perspective view showing the preferred embodiment of a riser according to the present invention.

FIG. 9 is a perspective showing the preferred embodiment of a load-carrying system in the ascending form.

FIG. 10 is a perspective showing the ascending form of the load-carrying system being used to climb stairs.

FIG. 11 is a perspective showing the ascending form of the load-carrying system being used to climb stairs.

FIG. 12 is a perspective showing the ascending form of the load-carrying system deploying a riser combination in order to climb stairs.

FIG. 13 is a perspective showing the ascending form of the load-carrying system deploying a riser combination in order to climb stairs.

FIG. 14 is a perspective showing the ascending form of the load-carrying system deploying a riser combination in order to climb stairs.

FIG. 15 is a perspective view of a hexagonal drum showing the arrangement of sensors being attached thereon.

FIG. 16 is a perspective view of a hexagonal drum showing the arrangement of sensors being attached thereon and the deployment of a riser combination once a stair is detected and analyzed for mounting.

FIG. 17 is a perspective view showing the descending form of the load-carrying system with an attached conveyor belt and being deployed in preparation for descending an obstacle.

FIG. 18 is a perspective showing the descending form of the load-carrying system with an attached conveyor belt and being deployed within a bottom deployment unit.

FIG. 19 is an exemplary computer with means for receiving sensor data and storing said data in a data storage system.

FIG. 20 is an exemplary computer with means for receiving sensor data and storing said data in a data storage system.

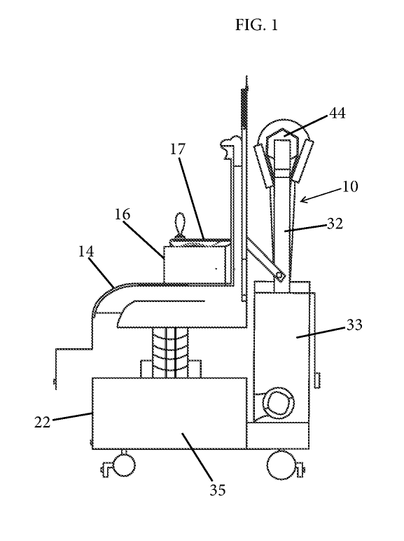

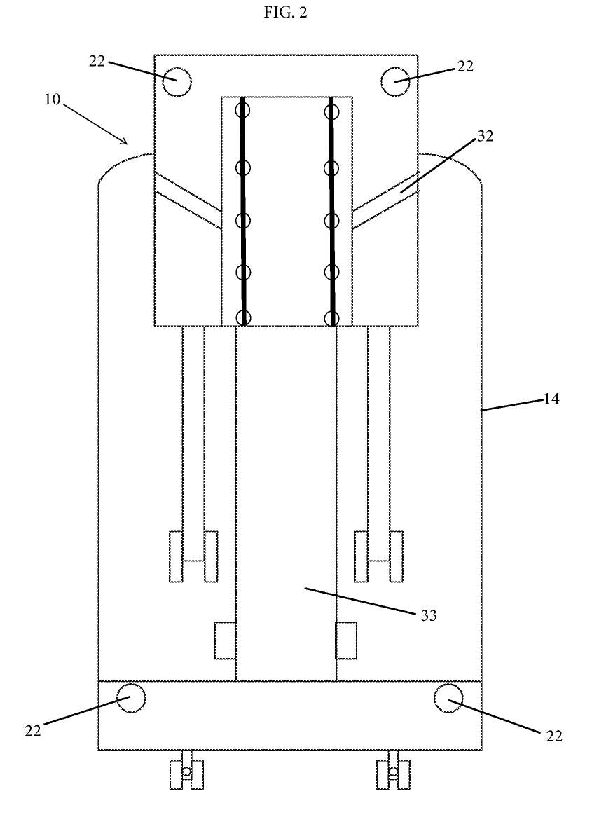

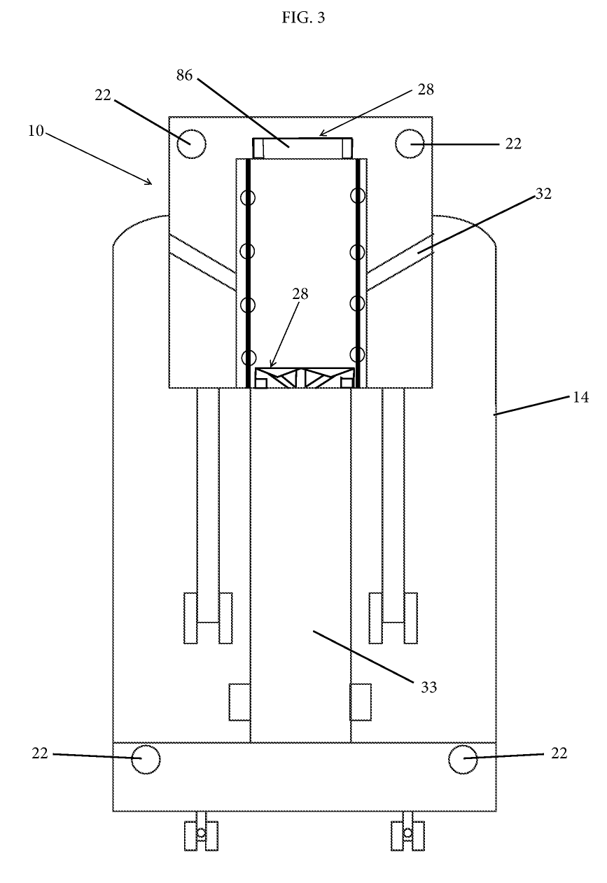

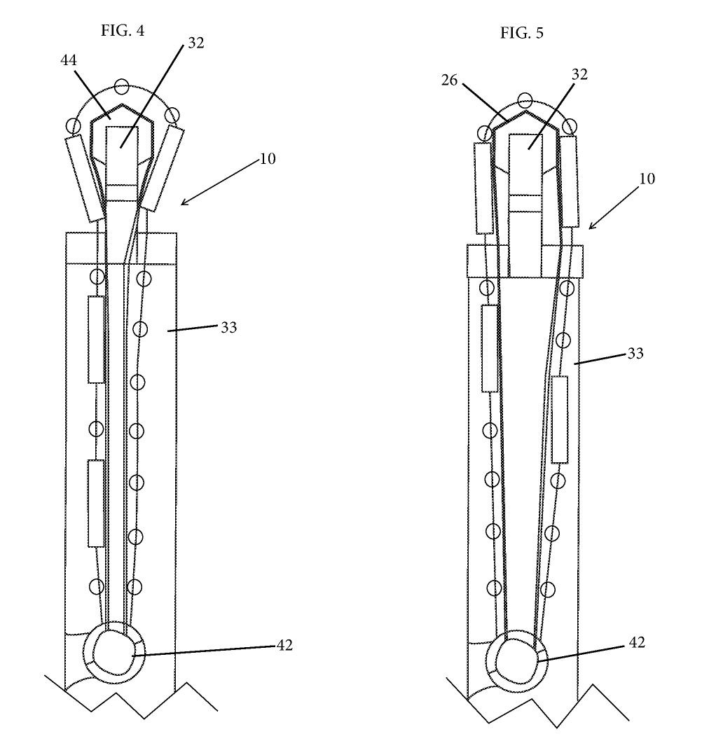

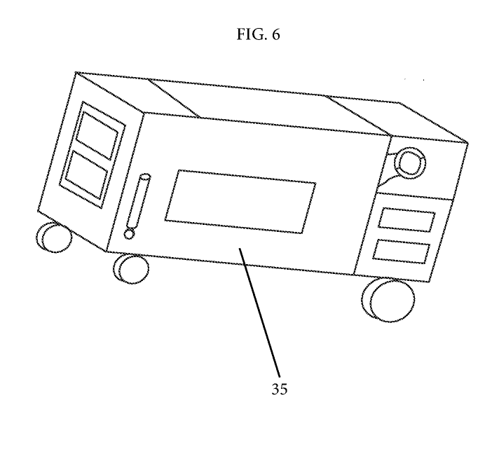

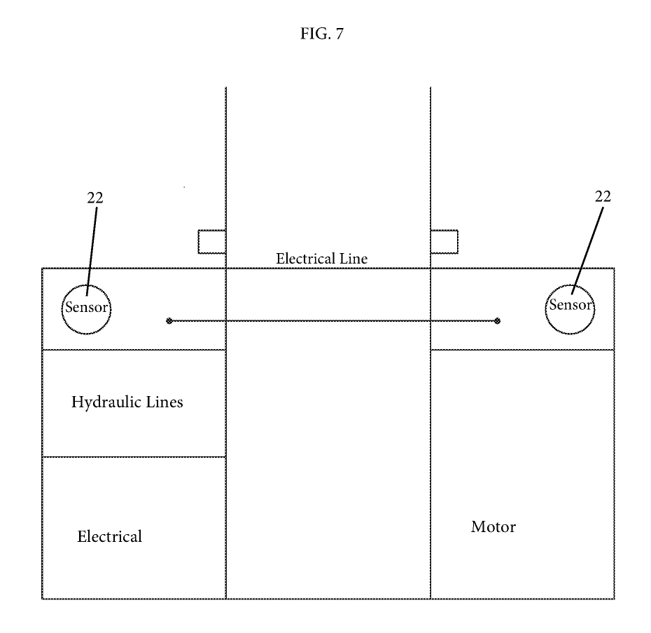

### DETAILED DESCRIPTION OF THE INVENTION

A load-carrying system 10 for ascending and descending an obstacle 12 and for connection to a load-carrying device 14 is presented. Additional examples of load-carrying devices 14 can include wheelbarrows, load-carrying slings, power chairs, small locomotives, etc. The load-carrying device 14 can have direct communication with a computer system 16 with means for receiving data 18 from an obstacle warning system of sensors 22 and storing said data 18 in a data storage system 24. The computer 16 is adapted to review, measure, and read the data 18. The computer 16 performs further computations from the data storage system 24. Said computer system 16 can be used with a viewing panel 17 being attached above the computer system 16.

Another feature of the present invention is to provide sensors 22 that detect an obstacle 12 in a predetermined position relative to the face 86 of a riser 28 or a pre-determined pattern of obstacles 12 based on data 18 within the data storage system 24. The sensors 22 can be organized to make singular or combination measurements of distance, direct contact, height and pressure. The sensors 22 are connected to a conveyor belt 26 with a plurality of risers 28 being permanently connected thereon. The conveyor belt 26 is then moved when one or more of the sensors 22 provide distance, relative height, angular, and related data 18. The sensors 22 are integral with the exterior of the risers 28 and movement between two obstacles 12 causes reconfiguration of the computer system 16 and the immediate realignment of the risers 28 on an expanded conveyor belt 26. The sensors 22 thereby functioning as width and height measuring devices and determining the distance between a riser 28 and an obstacle 12.

Ascending 32 and descending arms 34 incorporating the elements described herein and being adapted to house a conveyor belt 26 and a plurality of said risers 28 can be attached to a load-carrying device 14. The conveyor belt 26 features sensors 22 and piano hinges 38 that are permanently attached thereon. The piano hinges 38 can be strength composite piano hinge 38 type assemblies that are secured to the conveyor belt 26 and have an integral structure with a mating relation and form interconnected sections of the conveyor belt 26. The interconnected sections of the conveyor belt 26 expand when the arms 32, 34 are deployed. The conveyor belt 26 receives a first signal from the computer system 16 and the conveyor belt 26 expands when the climbing arms 32, 34 are in a state of rest. The conveyor belt 26 is continuous and orbitally movable around a circular drum 42 and a polygonal drum 44. The polygonal drum 44 in turn is driven by a motor 46 that can be connected to the load carrying device 14. For example, as shown in FIG. 7, a motor 46 is located at the rear end of a driver seat with outwardly extending hydraulic tubes and electrical wires. A first switch can be located below a driver seat with drive assemblies located laterally with respect to the location of the motor 46.

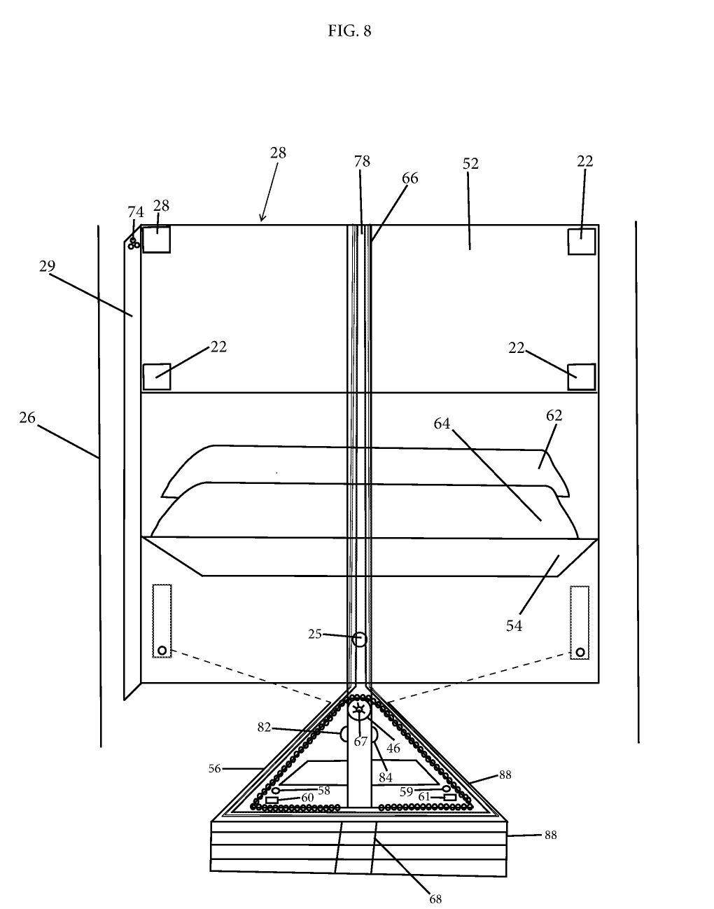

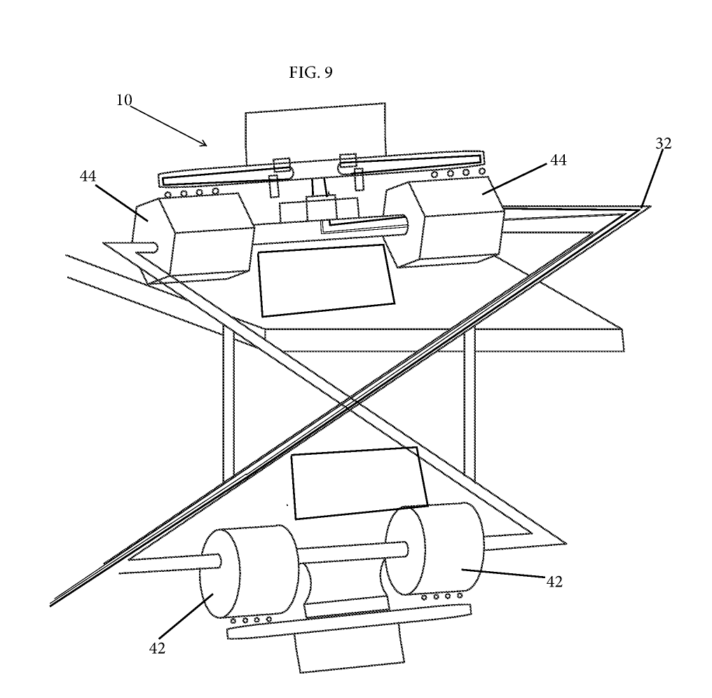

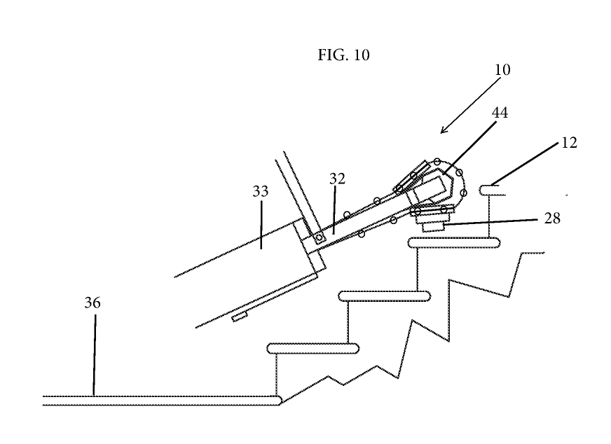

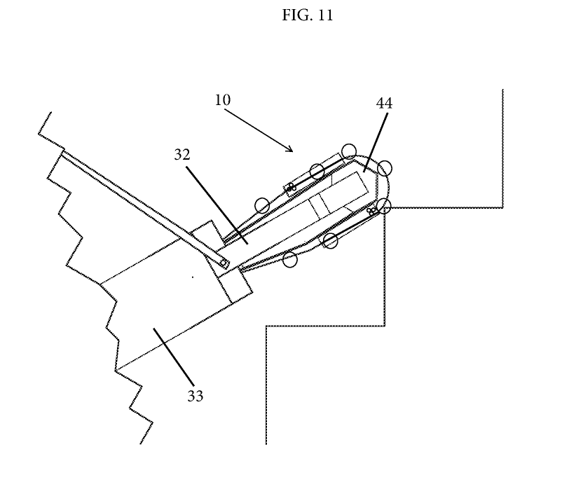

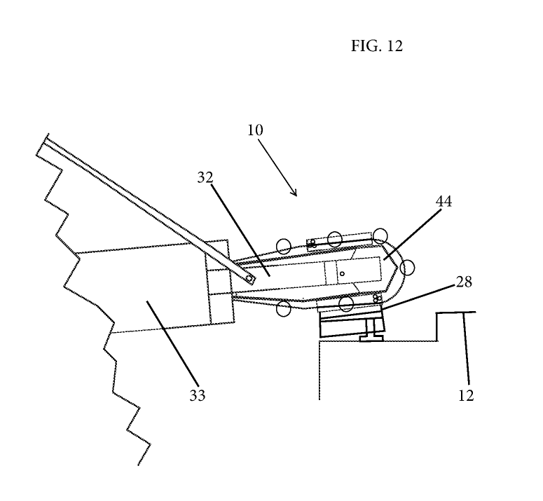

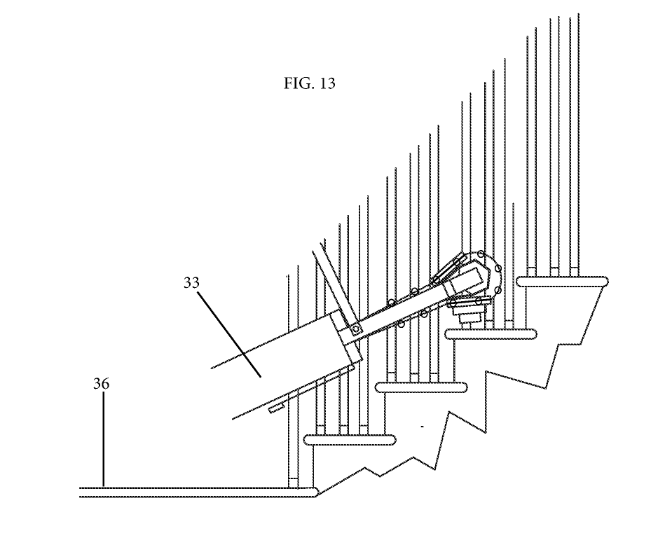

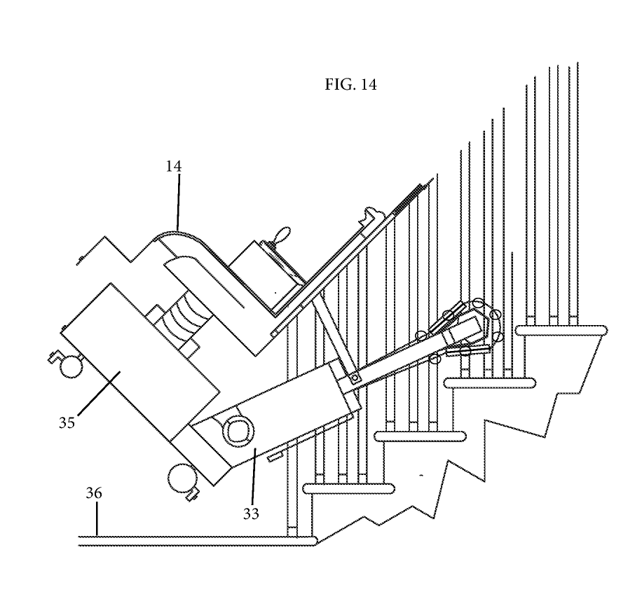

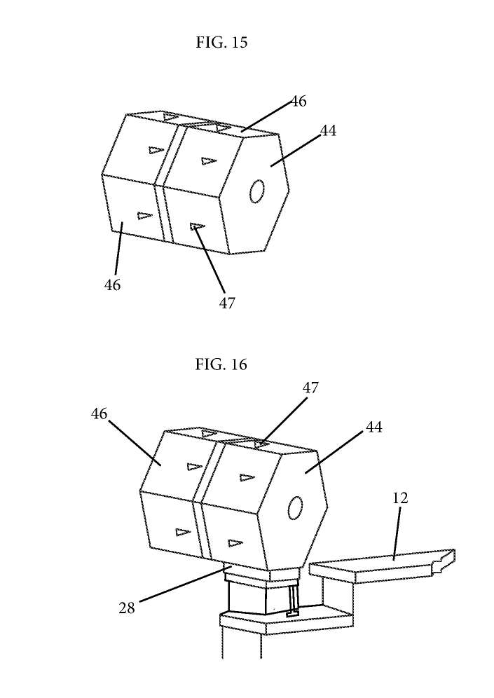

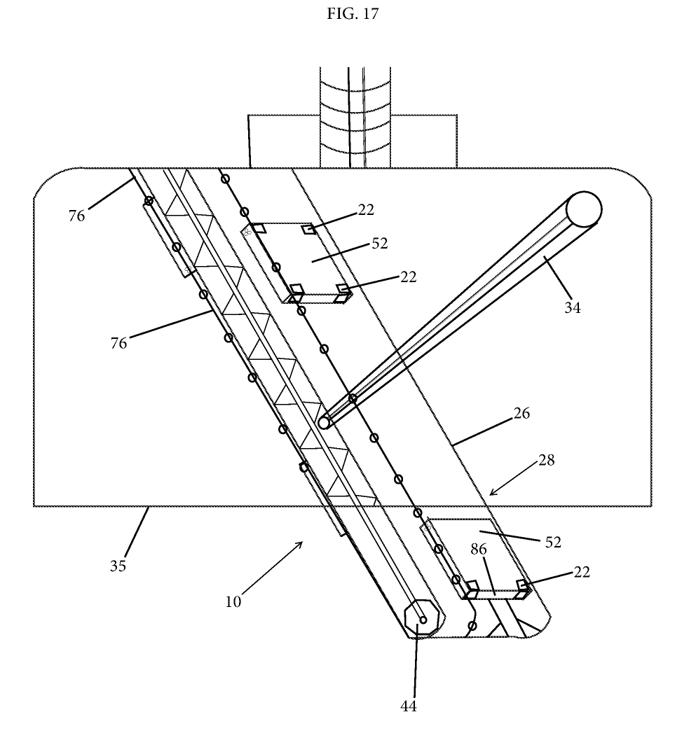

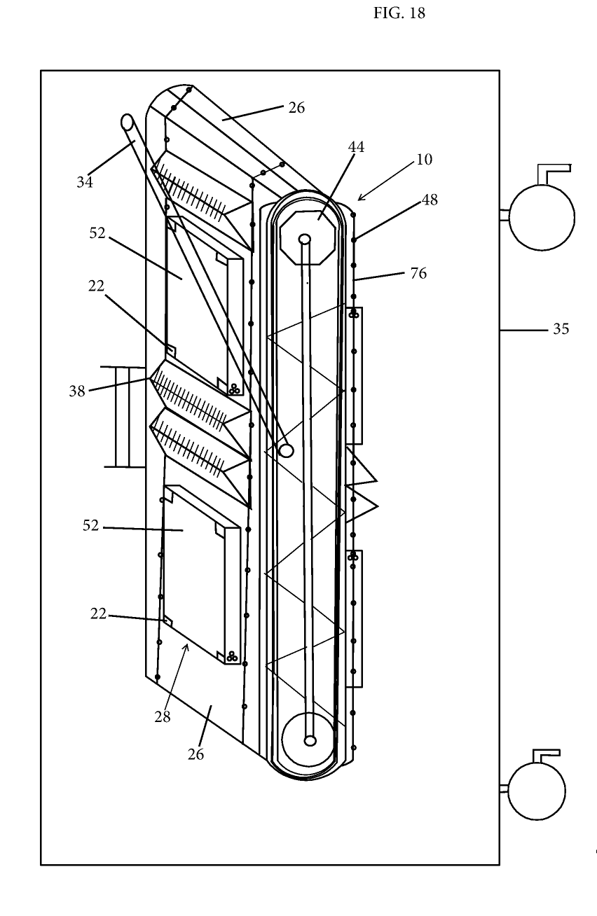

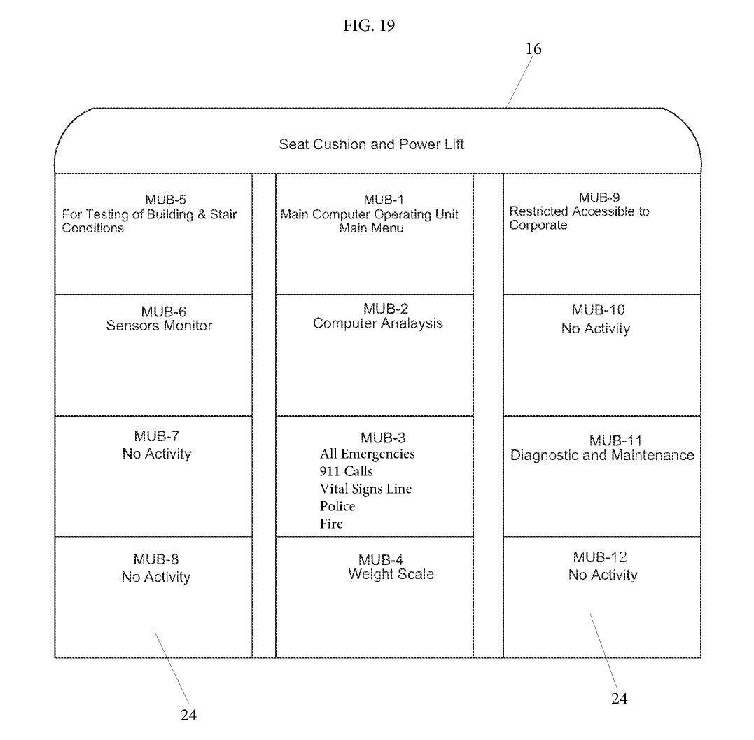

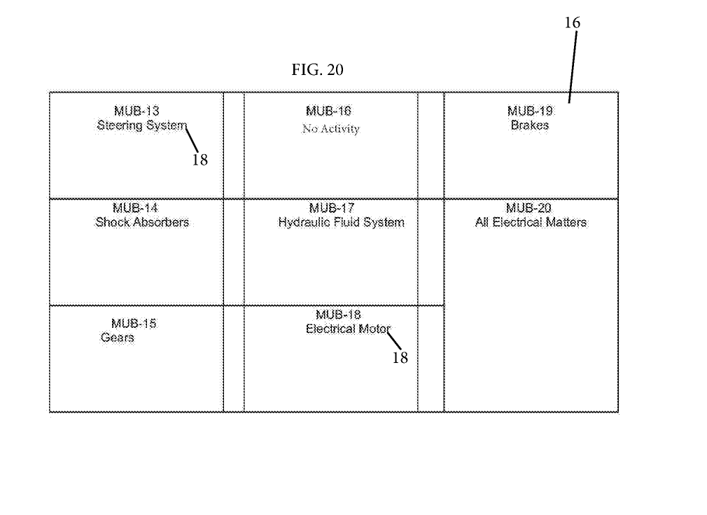

The polygonal drum 44 has a plurality of lateral faces 45 with additional cam sensors 47 being embedded thereon. The sensors 22 are in direct communication with the computer system 16 and further control the riser 28 operations, hydraulic fluid lines, the spacing of the risers 28, activation of the hydraulic beam 66, base functioning, and operation of the lifting jacks 58, 59, 60 and 61. The plurality of lift jacks can have multiple functions. For example FIG. 8 shows a lift jack X 58 which is a lift jack on the left side of the floating triangle. Lift jack X 58 can be used to lift and lower the floating triangle 53. A lift jack Y 59 is the lift jack on the right side of the floating triangle. This lift jack lifts and lowers the floating triangle 53 on the right side. Lift jack W 60 tilts the side wall and face the climbing base 56 on the right side. This allows for a better fit when the system 10 is climbing. Lift jack T 61 tilts the side wall and face of the climbing base on the left side. This allows for a better fit when the device 10 is climbing.

The eyelets 48 retain the risers 28 in a linked system and executing a straight line of the risers 28 until the risers 28 reach a selected position for deployment from the conveyor belt system 26. The conveyor belt system 26 thereby deploying the risers 28.

Each riser 28 features an exterior riser housing 52 with a bottom enclosing flooring unit 54, a climbing base 54 for coordinated upward, downward and angular movements based on automatic calculations from the sensors 22, lift jacks 58 adapted for use in mounting the obstacles 12, a motor 46 for directing the riser 28 to ascend or descend the obstacle 12, and a plurality of sensors 22 for automatic riser 28 functioning and automatic opening and closing arm sensors 22 after direct communication with the computer system 16.

The conveyor belt 26 can have structural braces for giving the conveyor belt 26 strength. The material for the braces can be of a material that provides relatively high strength when the system is being deployed in lateral positions. The strength or thickness of the structural brace can be determined based on the type of loading carrying device 14 being used. A carrying loading device 14 with minimal mass would require less strength in the event of a deployment. This can also depend on the strength and stiffness of the conveyor belt 26.

The riser housing 52 is an exterior housing for a first riser extension 62 and a second riser extension 64. As the riser 28 approaches an obstacle 12, the extensions 62,64 are positioned at a specific distance from one another and function as sectional extensions 62, 64 while the base 54 is lifted into a position to heighten or lower the riser housing 52. Support brackets can be attached to each side of the riser wall 29. The brackets can support the movement of the climbing base 54.

The flooring unit 54 is adapted to be laid on a generally flat surface facing an obstacle 12. The unit has a generally flat and rectangular shape and a capacity for downward deflexure. A resilient flooring 54 construction is desired. However, the exact size and shape of the flooring 54 are not critical. The climbing base 56 has an inner hydraulic beam 66 welded in cooperation with a rotatable element 67 at a 90-degree angle from the climbing base 56 and a tilt hinge 68 along with a plurality of lift jacks 58 are welded at the front section of the base 56 and a tension retaining system 74 maintains the tension of guide wires 76. The rotatable element 67 can be a capstan or similar revolving cylinders with a vertical axis used for winding a rope or cable. It can be powered by said motor 46 as described herein.

The inner hydraulic beam 66 has a hollow core 78 and is centrally positioned on the interior of the riser housing 52 and extends through the first riser extension 62 and the second riser extension 64. It functions as a passageway for hydraulic and electrical lines and further housing a left 90-degree angular measurement device 82 and a right 90-degree angular measurement device 84. The hydraulic beam 66 functions as the zero clearance point for the right 90-degree measurement device 84 and the left 90-degree measurement device 82. It is further adapted to engage the first 62 and said second riser extensions 64 to prevent rotation with respect to the same and in cooperation with the rotatable element 67.

The climbing base 54 is a climbing center for all climbing operations with the hydraulic beam 66 being central to the left and right angular devices. The angular movement of the climbing base 54 must match the angular measurement of the obstacle 12. For example, when climbing winding stairs, the computer 16 collects the information from the sensors 22. The computer 16 then transfers that information to the motor 46 so that the desired task could be completed. The climbing base 54 is moved further to the left or the right of said motor 46 depending on the angular displacement of said obstacles 12 when being encountered by the sensors 22.

The tilt hinge 68 tilts the face 86 of the riser housing 52 and is a center of tilting during or after deployment. It can be small in size and capable of accumulating a torque and being a bracket welded to the top face of the climbing base 54. The tilt hinge 68 also supports the face of the climbing base 54 in angular positions. The guide wires 76 stretch alongside said risers 28 in a horizontal position and are in constant engagement with the side walls 88 of the climbing base 54.

In use, said plurality of risers 28 rotate on a horizontal plane 36 of 180 degrees. When held on the horizontal plane 36, said risers 28 follow the up, down or angular movements of said climbing base 54 while said hydraulic beam 66 permits longitudinal movement in combination with the movement of said flooring unit 54. The hydraulic beam 66 expands upwards from an undeployed position upon engagement of the sensor 22 system with a ground obstacle 12 and the angular measurement of the obstacle 12. The riser 28 lines up with the obstacle 12 while the lift jacks 58, 59, 60, 61 applies pressure to the obstacle 12. The jacks 58, 59, 60, 61 are triggered to lift or lower the device 10 to the next obstacle 12. The hydraulic beam 66 is adapted to support the desired lifting weight limits of 800 pounds. Stability of the hydraulic beams 66 can be attained with reinforced brackets used to increase the stability of the beam 66 to carry the desired weight. Support bracket pins can also be used to secure the support bracket to the wall 29 of the riser 28.

The climbing arm can be attached to a load-carrying device 14 such as a wheel chair. The hydraulic arm can be connected to the back frame when used as an ascending stair or at the base 54 when used for descending a chair. Each arm being organized and attached as described herein. The wheel chair would thereby function as a stair climbing or descending wheel chair having sensors 22 being connected thereon for sensing the presence of an obstacle 12. The ascending arm 32 and the descending arm 34 can be housed in top deployment units 33 and bottom deployment units 35.

A master utility box can house the computer system 16 arranged to accept and produce signals and cooperate with a power supply unit arranged along a back plate. In the case of a load-carrying device 14 transporting heavy items, a level can be mounted on the left and right side of a frame to assist in maintaining balance while ascending and descending stairs. The level can further function as a position indicator for the computer system 16. Sensors 22 can be attached to each side of the frame and being substantially in parallel relation to the stairs.

The load-carrying system 10 can be equipped with a plurality of extendable balance transfer jacks 58, balance transfer wheels, front and rear drive wheels and a breaking system to further facilitate it's functioning along with a load-carrying device 14. In addition, the descending arm 34 and ascending arm 32 can have a pair of adjustable hydraulic arms being supported by inner braces being axially connected to the outer midpoints of the plurality of drums 42, 44 shown in the drawings. In the descending form, the top drums can be positioned in a parallel configuration on the top wall of the bottom deployment unit 32. Both drums 42, 44 in the ascending and descending forms can be connected at their midpoints with circular extension rods. The polygonal drum retaining the sensory-type feature of having a plurality of lateral faces 45 and determining the spacing with said cam sensors 47 being in direct communication with the distance measurements of the additional sensors 22. The cam sensors 47 control the pie housing, spacing of pie, timing of operations, order of operations, order of priority, and other operations.

The polygonal drum 44 is articulated substantially to the angular measurement of an obstacle 12 whereby a load-carrying device 14 may be supported in a level position with portions of the device 12 resting on additional obstacles 12 or surfaces and with other portions of the device 14 on another stair or surface at a different elevation. The polygonal drum 44 can have a central axle functioning as the passageway for electrical wires, guidewires, hydraulic fluid lines and other service passageways.

In the case of ascending an obstacle 12 while using the load-carrying system 10 on a load-carrying device 14 such as a power lift chair, the chair prepares to ascend said obstacle 12 by being in close proximity to the obstacle 12. The sensors 22 collect location information about the chair in relation to the obstacle 12. At least one embodiment of the invention as described can include a user inputting a computer order to ascend the obstacle 12. Based on specific computer programming, the chair can be programmed to move within two feet of the stairs and the chair is further repositioned so that the rear of the chair is facing the obstacle 12.

In order to maintain balance during use, the load-carrying system 10 can be programmed for the simultaneous deployment of balancing arms and balance transfer wheels. This can be done in preparation for climbing and will depend on the load-carrying device 14 being attached thereon.

The inner braces, extension rods, circular drum 42 and the polygonal drum 44 can be used as conduit for power lines. Depending on the size and location of the load-carrying system 10, the circular drum 42 can control all utilities and hydraulics fluid lines. A solid construction of the load-carrying system 10 would necessitate that all electrical and hydraulic lines are fixed in place and remain stable when the system 10 is in use. The circular drum 42 can further be utilized to set the necessary tension in the conveyor belt 26 for proper operations of the load-carrying system 10.

One preferred type of conveyor belt construction in the ascending arm 32 can include the conveyor belt being separable into left and right sides and the conveyor belt being separable when turnbuckles are removed. The right side and the left side of said conveyor belt being pulled together by the turnbuckles and further equipped with mounted rollers. These can be placed on the surface of the drums 42, 44 and further reducing friction when the conveyor belt 26 is in use. The guide wires 76, utilities and hydraulics that move with the conveyor belt can be attached to its rear and bottom portions for mobility.

The load-carrying device 14 can be used as wheelchair incorporating additional elements that support the user. For example, a head rest can be placed just above the seat cushion while a rigid body harness is placed therein and comfortably against the back of a user. The right body harness can be designed to allow the user to stand. Sensors can also be placed on the harness to read and record vital signs.

A standing feature incorporating an extended level can be incorporated into the load-carrying device 14. Additional features allowing the user to stand while supported by a belt and a rigid body harness can be included. These features would promote safe usage of the load-carrying device 14 and prevent falls.

What is claimed is:

1. A load-carrying system for ascending and descending an obstacle and for connection to a load-carrying device having a computer system with means for receiving data from an obstacle warning system of sensors and storing said data in a data storage system, said computer reviewing said data, measuring said data, reading said data, performing computations from said data storage system and monitoring a plurality of valve release on said load-carrying device further comprising:
a. said computer system being usable with a viewing panel being attached above said computer system;
b. said sensors being connected to a conveyor belt with a plurality of risers being permanently connected thereon, said conveyor belt is then moved when one or more of said sensors detect an obstacle in a predetermined position relative to the face of said riser or a pre-determined pattern of obstacles based on data within said data storage system; said sensors being integral with the exterior of said risers and movement between the two of said obstacles causing reconfiguration of said computer system and immediate alignment of said risers on an expanded conveyor belt; said sensors being distance, angular, height and width measuring devices and for determining the distance between said riser and said obstacle;
c. an ascending arm and a descending arm combination being adapted to house a conveyor belt and a plurality of said risers for ascending and descending obstacles; said ascending arm and said descending arm being adapted for housing in top deployment units and bottom deployment units respectively;
d. said conveyor belt having sensors and piano hinges being permanently attached thereon, said piano hinges being strength composite piano hinge type assemblies that are secured to the conveyor belt and having an integral structure with a mating meshing relation and forming interconnected sections of the conveyor belt, said interconnected sections of said conveyor belt expand when said ascending arm and descending arms are deployed, said conveyor belt system receiving a first signal from said computer system, said conveyor belt expanding when said arm is in a state of rest, said conveyor belt being continuous and orbitally movable around a circular drum and a polygonal drum, said polygonal drum in turn being driven by a motor that is connected to a load carrier, said polygonal drum having a plurality of lateral faces with, said cam sensors being mounted thereon, said cam sensors control riser spacing, timing of operations, order of operations, order of priority and other operations; said eyelets retaining said risers in a linked system and creating a straight line of said risers until said risers reach a selected position for deployment from said conveyor belt system, said conveyor belt system being used for deploying said risers;
e. said risers having an exterior riser housing, a flooring unit for enclosing the bottom of said riser housing, a climbing base for coordinated upward, downward and angular movements based on automatic calculations from said sensors, lift jacks adapted for use in mounting said obstacles, a motor for directing said riser to ascend or descend said obstacle, and a plurality of sensors for automatic riser functioning and automatic opening and closing arm sensors after direct communication with said computer system;
f. said riser housing being an exterior housing for a first riser extension and a second riser extension, said extensions being positioned at a distance from one another and constituting sectional extensions lifting said climbing base into a position to heighten or lower said riser housing when approaching said obstacle;
g. said flooring unit being adapted to be laid on a generally flat surface facing an obstacle, said unit having a generally flat and rectangular shape and having a capacity for downward deflexure;
h. said climbing base having an inner hydraulic beam welded at a 90 degree angle from said base using a rotatable element, a tilt hinge along with a plurality of lift jacks being welded at the front section of said base and being controlled by said valve, a tension retaining system maintaining the tension of guide wires; said inner hydraulic beam having a hollow core and being centrally positioned on the interior of said riser housing and extending through said first riser extension and said second riser extension, said hydraulic beam being a passageway for hydraulic and electrical lines, said hydraulic beam housing a left 90-degree angular measurement device and a right 90-degree angular measurement device, said hydraulic beam being the zero clearance point for said right 90 degree measurement device and said left 90-degree measurement device, said hydraulic beam being adapted to engage said first and said second riser extensions to prevent rotation with respect to the same and in cooperation with said rotatable element; said tilt hinge tilts the face of said riser housing and being a center of tilting, said tilt hinge being designed small in size and being capable of accumulating a torque and being a bracket welded to the top face of said riser housing, said tilt hinge supporting the face of said climbing base in angular positions; said guide wires being stretched along said risers in a horizontal position and being in engagement with the side walls of said climbing base;
i. in use, said plurality of risers rotate on a horizontal plane of 180 degrees; said risers follow the up, down or angular movements of said climbing base while said hydraulic beam permits longitudinal movement in combination with the movement of said flooring unit, said hydraulic beam expand upwards from an undeployed position upon engagement of the sensor system with a ground obstacle and the angular measurement of the obstacle, said riser lining up with said obstacle while said plurality of jacks applies pressure to said obstacle, said jacks being triggered to lift or lower said device to the next obstacle.
